(19) United States
(12) Patent Application Publication
(10) Pub. No.: US 2024/0020745 A1
(43) Pub. Date: Jan. 18, 2024

(54) METHOD AND SYSTEM FOR ARTISTIC IMAGERY CONSULTATION

(71) Applicant: Irene ARENA, Las Vegas, NV (US)

(72) Inventor: Irene ARENA, Las Vegas, NV (US)

(21) Appl. No.: 18/350,708

(22) Filed: Jul. 11, 2023

Related U.S. Application Data
(60) Provisional application No. 63/368,239, filed on Jul. 12, 2022.

(51) Int. Cl. G06Q 30/0601

(52) U.S. Cl. CPC G06Q 30/0621

(57) ABSTRACT

The present invention relates generally to a method and system for an artistic imagery consultation. More specifically, the present invention is a method to perform an artistic imagery consultation including the steps of filling a questionnaire, performing a facial, skin tone, hair colorimetry, clothing shade, somatotopic, and optical enhancement analyses, and generating the results to improve one's image. The tool kit system includes a questionnaire, charts, hair samples, and hair extensions to assist performing a facial, skin tone, hair colorimetry, clothing shade, somatotopic, and optical enhancement analyses to improve one's image.

### CROSS-REFERENCE TO RELATED APPLICATIONS

This application claims the benefit of U.S. Patent Provisional Application Ser. No. 63/368,239, filed Jul. 12, 2022, incorporated by reference herein in its entirety.

### COPYRIGHT NOTICE

In accordance with 37 C.F.R. § 1.71(e), a portion of the disclosure of this patent document contains material which is subject to copyright protection. The copyright or mask work owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to a method and system for consultations. More specifically, the present invention is a unique system in a tool kit that allows a person of ordinary skill in the art to do an artistic imagery consult in their studio or any location that has a mirror for their clients.

### BACKGROUND OF THE INVENTION

The field of image consulting is the advising on improvements and adjustments to one's personal appearance. Many people desire to improve or augment their physical appearance through hair styling or skin care treatments. One problem with this field is the financial expense associated with an image consultation, which can be in the thousands of dollars. This high cost deters many would-be customers from obtaining an image consultation.

Another problem with this field is that if a person wants a new hair style, that person will normally utilize the services of a hairdressing professional. The majority of hairstylists do not have the knowledge or tools to give their customers their best image. When that person wants an updated wardrobe, that person will go to a retail clothing store and select out different clothes to purchase. The purchase of these new clothes would be based on a person's own personal preferences, and not necessarily based on the color and clothing style that best fits that person's physical appearance. In an artistic image consult, physical appearance includes facial shape, skin tone, makeup application, hair color, styling and body type. Further, if that same person wants to change their public persona through a change in hair styling and clothing to match that person's body type, that person would need to go to an image consultant. This entire process requires multiple consultations with different professionals and purchase of new clothes at a retail clothing store. In addition to the cost, this process is time-consuming.

There remains a need to provide an effective, yet cost-efficient, system for a person of ordinary skill in the art to assist customers with a full image consultation that includes finding one's power color for hair, skin, clothes, and body type.

### SUMMARY OF THE INVENTION

The present disclosure relates generally to a method and system of providing an artistic imagery consultation. More specifically, to a tool kit that contains different items to successfully discover a person's power colors and how to create illusions with hair color and hair styling to balance face shape and body shape for a customer in one session.

### BRIEF DESCRIPTION OF DRAWINGS

In accordance with 37 C.F.R. § 1.84(a)(2)(iii), the patent or application file contains at least one drawing executed in color. Copies of this patent or patent application publication with color drawing(s) will be provided by the Office upon request and payment of the necessary fee.

FIG. 1 is an algorithmic flowchart of the method of the present invention.

FIG. 2 is an illustration of the housing unit of the tool kit system according to the present invention.

FIG. 3 is an illustration of the charts affixed to the bottom of the lid of the tool kit system, according to the present invention.

FIG. 4 is an illustration of the scarves that are included elements of the tool kit system to assist with skin tone selection, according to the present invention.

FIG. 5 is an illustration of hairclips and bangs that are included elements of the tool kit to select best hair color.

FIGS. 6A and 6B are illustrations of hair extension clips and bangs that are included elements of the tool kit system according to the present invention.

FIGS. 7A, 7B, 7C and 7D are illustrations of scarves that correspond to clothing selection that are included elements of the tool kit system according to the present invention.

FIGS. 8A and 8B are illustrations of the charts used to determine facial shape, power color, makeup contour, body shape, and eyewear, and are included elements of the tool kit system according to the present invention.

FIG. 9 is an illustration of the total elements composing the tool kit system according to the present invention.

### DETAILED DESCRIPTION OF THE INVENTION

All illustrations of the drawings are for the purpose of describing selected versions of the present invention and are not intended to limit the scope of the present invention.

A person of ordinary skill in the art is defined as an image consultant or a hairdressing or makeup professional, employed in the hair and makeup and styling industry.

Terminology used in this specification is deemed to have the common meaning of that particular word or description, unless otherwise indicated, including colors and geometrical shapes.

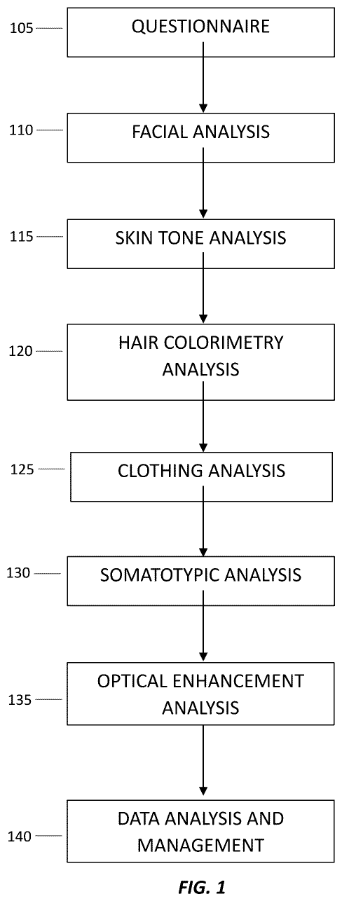

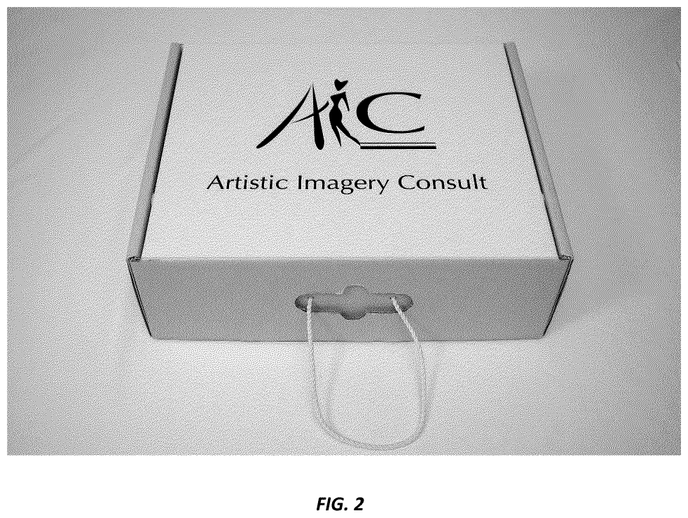

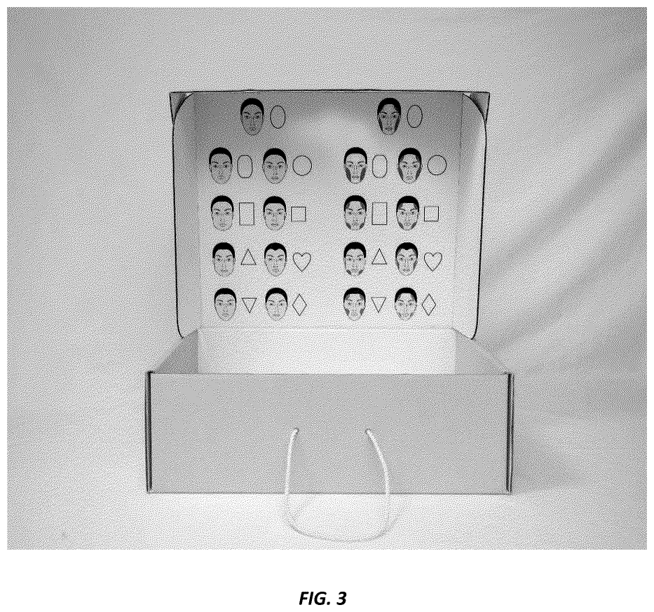

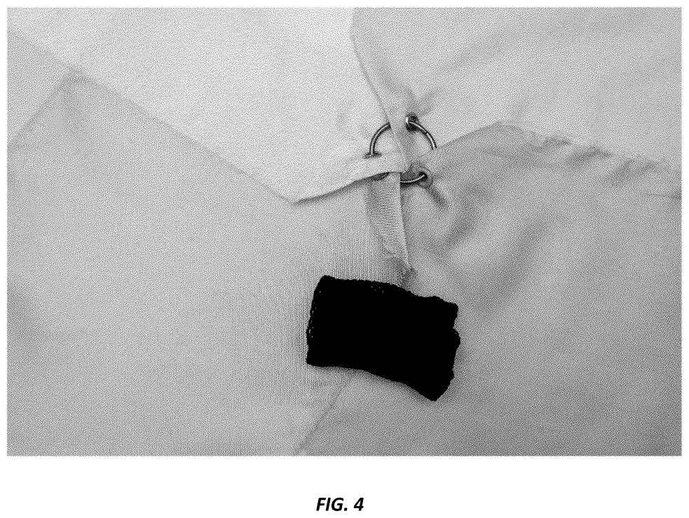

The method and system according to the present invention includes a method for conducting a comprehensive image consultation, as shown in FIG. 1. An initial questionnaire 105 may be completed to assess a customer's overall expectations and goals in the image consultation. A facial analysis 110 may be performed to analyze a customer's facial structure. A skin tone analysis 115 may be performed to assess a customer's skin pigmentation. An analysis of hair accessories 120 may be performed to enhance the facial, skin tone, and makeup analyses. A clothing analysis 125 may be performed to determine the best clothing shades for a customer based on a customer's facial, skin tone, and hair colorimetry analyses. A somatotopic analysis 130 may be performed to assess a customer's body or physical type. An optical enhancement analysis 135 may be performed to assess eyewear to augment the facial, makeup, skin tone, hair color, clothing, and somatotopic analyses. The data results are organized and managed 140 for future reference in further image consultations.

According to the preferred embodiment, an image consultation conducted by a person of ordinary skill in the art with a customer during a hairdressing session. A person of ordinary skill is able to assess a customer's own natural physical appearance, including face, hair, skin, and body appearances. In doing so, a person of ordinary skill in the art, discussing in consultation with a customer, can make suggestions for an appropriate hair style, makeup, hair color treatment, and wardrobe color selection, in order to improve a customer's image, to balance face shape with body shape.

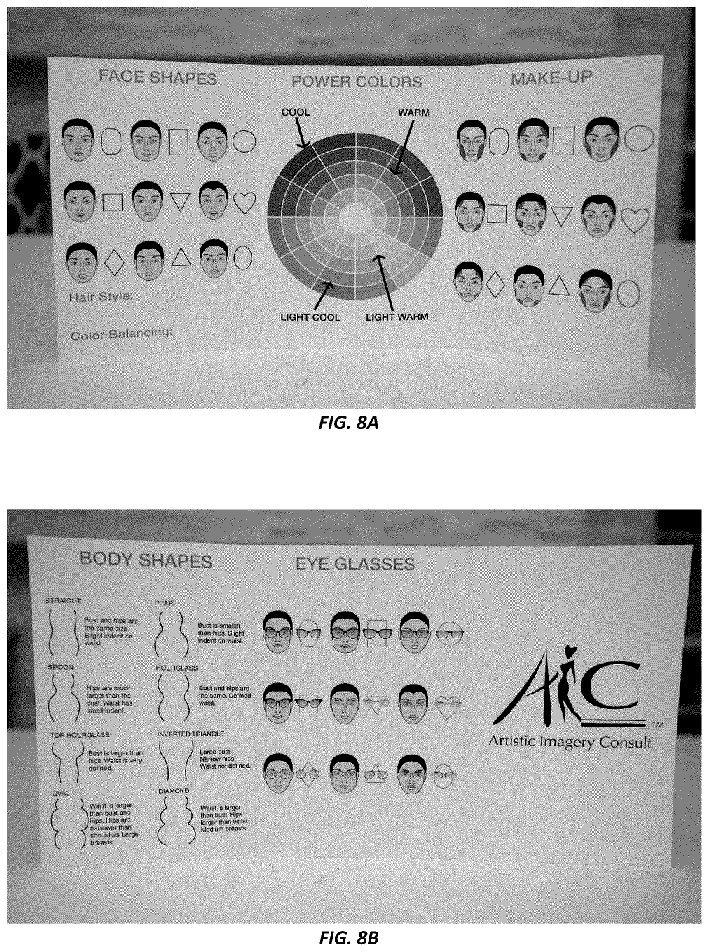

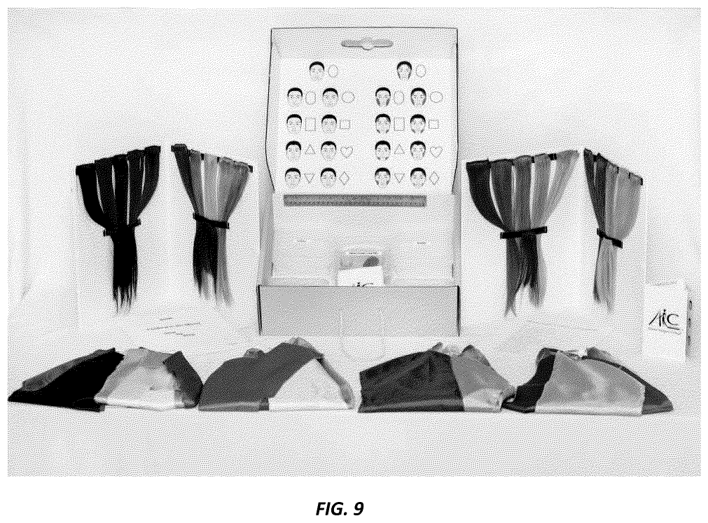

The system according to the preferred embodiment is the tool kit system, as shown in FIG. 9. The tool kit system may contain all elements of the present invention, including the initial questionnaire given to a customer. Also, the tool kit system may contain the charts showing the facial shapes, makeup contouring, power colors, body shapes, and eyewear, as shown in FIGS. 8A and 8B.

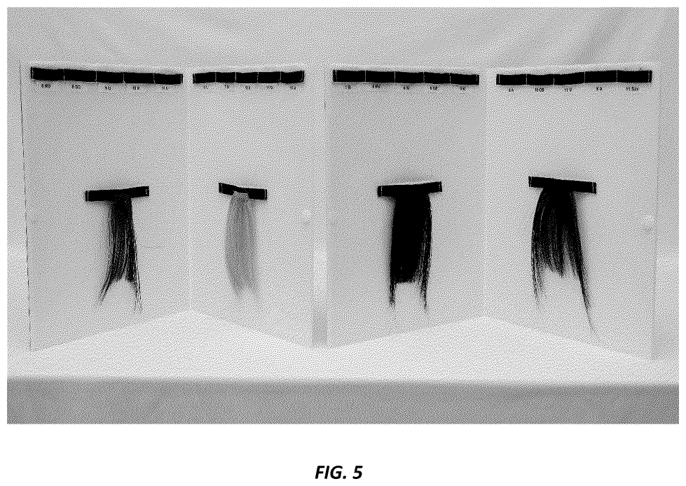

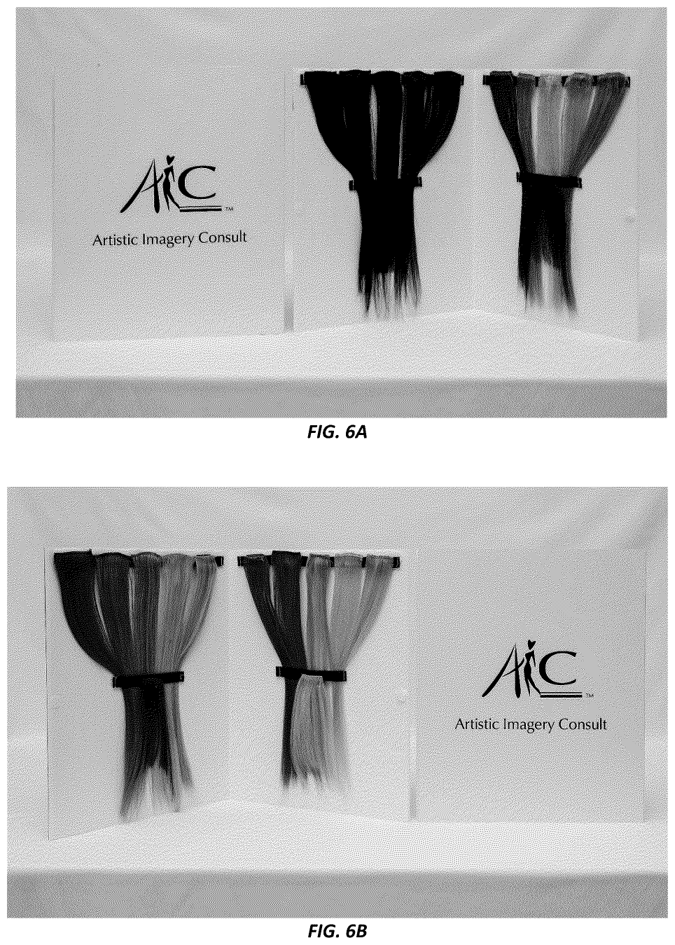

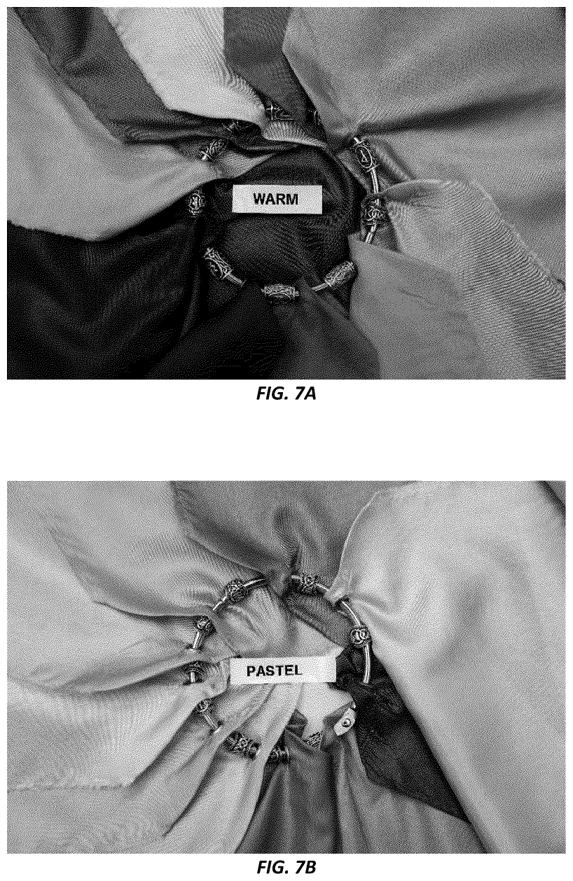

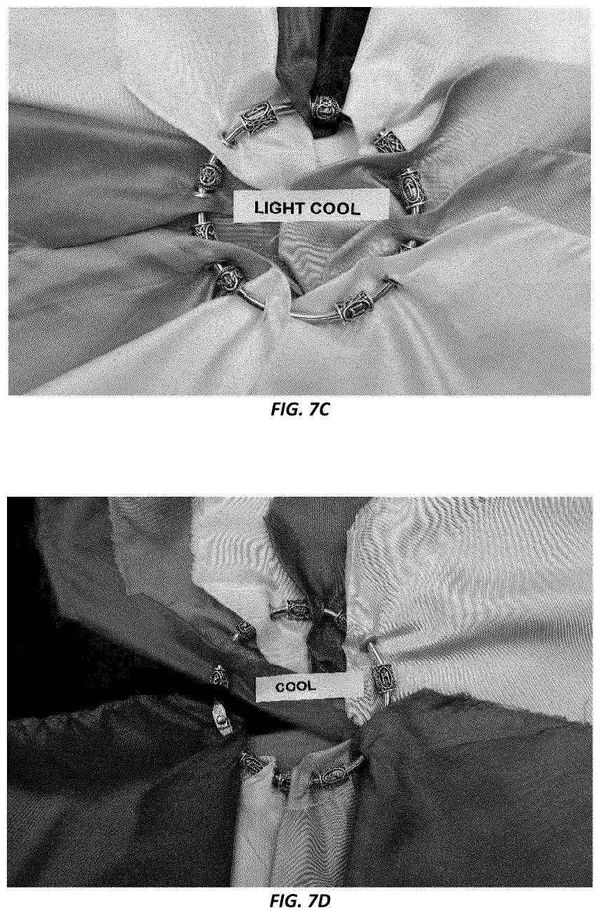

Further to the preferred embodiment, a person of ordinary skill in the art may utilize accessories commonly used in the hairdressing and image consultation professions, including hair clips, as shown in FIGS. 5, 6A and 6B, and scarves, as shown in FIGS. 7A, 7B, 7C and 7D, to assist in holding back a customer's hair for demonstration purposes, or to create a visual guide for color enhancement for improving a customer's overall stylistic image.

A chart demonstrating model eyewear may also be an element of the tool kit system, as shown in FIGS. 8A and 8B. Different generic faces corresponding to a particular facial shape displaying different eyewear is shown to a customer, to assist in the selection of a particular style of eyewear that a customer may purchase to improve on a customer's image and complement a customer's face and body features.

Further to the preferred embodiment, a chart containing model facial shapes may be included in the tool kit system, as shown in FIGS. 8A and 8B. The facial shapes are loosely correlated to a particular geometric shape, including oval, oblong rectangle, rectangle, round, square, triangle, inverted triangle, heart, and diamond.

In addition, a “Power Colors” chart may be included in the tool kit system, as shown in FIGS. 8A and 8B. The chart is a wheel of the different shades of colors, and correspond to a customer's skin tone, including gold, for warm skin tone; silver, for cool skin tone; light gold, for pastel skin tone; and white, for cool skin tone.

Said makeup chart may also be included in the tool kit system, as shown in FIGS. 8A and 8B. The makeup chart illustrates the different facial types and determines the ideal usage of makeup on a customer's corresponding facial type by showing how to contour to create the perfect oval shape.

The body shape chart, as shown in FIGS. 8A and 8B, illustrates different body physical types. The body types are straight, with bust and hips as same size and there is a slight indentation on the waist; pear, where the bust is smaller than hips and there is a slight indentation on waist; spoon, where the hips are much larger than the bust while the waist has a smaller indentation; hourglass, where the bust and hips are the same size but there is a defined waist; top hourglass, where the bust is larger than the hips and the waist is very defined; inverted triangle, where the bust is larger but the hips are narrow while the waist is not defined; oval, where the waist is larger than the bust and hips, but the hips are narrower than the shoulders and there are larger breasts; and diamond, where the waist is larger than the bust, while the hips are larger than the waist, and there are medium-sized breasts.

According to the preferred embodiment, the method for conducting the artistic imagery consultation typically contains eight steps in the process.

Questionnaire

Step 1: a questionnaire is provided in the tool kit system. The purpose of the questionnaire is to confirm a customer's desired outcomes for the image consultation, as well as discuss the expectations of a person of ordinary skill in the art for conducting the consultation. Questions included in the question may include:
What was your hair color at birth?
What is your natural hair color now?
What is your artificial color now?
What is your eye color?
What color are the specs in your eyes?
Do you wear make-up?
What is your favorite clothing color?
What color gets you compliments?
What color would you never wear?
How often do you change your style?
Wat are you looking to discover in this consultation?
What style celebrity personality are you closest to or would like to resemble?

### Facial Analysis

Step 2. In this step, a person of ordinary skill in the art may measure a customer's face to determine a customer's facial shape. First, measurement may be performed at the widest part of the forehead halfway between the eyebrows and hairline. Second, the measurement may be taken between the outer corner of one eye extending to the outer corner of the other eye. Third, measurement may be performed of the jawline, starting at the chin and extending to just below the ear. Fourth, measurement may be taken from the hairline to the bottom of the chin.

After the measurements of a customer's face are taken and recorded, a customer's facial shape may be determined based on the following shapes to determine best haircut and style:
Oval: an oval facial shape may be defined by a forehead width smaller than the cheekbone width, and the face's length is greater than its width. Additionally, the chin and jawline have more rounded features.
Rectangle: an rectangular facial shape may be defined by somatotopic a face length greater than the face's width. The forehead, cheekbones, and jawline are similar in size.
Oblong Rectangle: a rectangular facial shape may be defined by a face length greater than the face's width, similar to a rectangular facial shape, but with roundness around the head's edges.
Round: a round facial shape may be defined by the cheekbones and face's length are similar in size. Additionally, the cheekbones and facial length are larger than the forehead and jawline lengths. The forehead and jawline have similar measurements. Further, the jawline is more founded with less definition and angularity.
Square: a square facial shape may be defined by a jawline and forehead length, cheekbone width, and facial length and width all in similar parity. There is more angularity in the facial structure than a round facial shape.
Triangle: a triangular facial shape may be defined by a jawline measurement that is greater than the cheekbones. The cheekbones' measurement is greater than the forehead.
Inverted Triangle: an inverted triangular facial shape may be defined as the opposite in measurement from the triangular facial shape.
Heart: a heart facial shape may be defined by a forehead which measures greater than the cheekbones and jawline. The chin is also pointed.
Diamond: a diamond facial shape may be defined by a long facial length. This is followed, in descending size, by the cheekbones, forehead, and jawline. The cheekbones are high and defined, the chin is more narrow and pointed, and the hairline is more angular.

### Skin Tone Analysis

Step 3: In this step, the skin tone may be determined using the scarves accessories in the tool kit system, as shown in FIGS. 7A, 7B, 7C and 7D. The colors of the scarves may be held against a customer's shoulder and compared to the skin tone of a customer's face and arm. In the hair and makeup industry, the skin tones correspond to the undertones of the skin. The skin tone determines the type of makeup that will best balance with a customer's skin tone. The skin tone colors, as known to a person of ordinary skill in the hair and makeup industry, are “warm,” “cool,” and “pastel.” The corresponding color of scarves for a “warm” skin tone is gold; for “pastel,” it is light gold; and for “cool,” it is either silver or white.

### Hair Colorimetry Analysis

Step 4: In this step, a person of ordinary skill in the art may use the hair tone samples and clip-on hair extensions found in the tool kit system, and as shown in FIGS. 5, 6A and 6B, to perform a hair colorimetry analysis to best improve a customer's image profile. Using the skin tone analysis from Step 3, a person of ordinary skill in the art may display the hair tone samples and clip-on hair extensions against a customer's face and skin to determine the appropriate hair color tone for a customer and the technique to balance the face shape.

The “Cool” hair tone colors include Blue Black, Cool Red, Dark Brown, Wine Red, Chocolate Brown, Ash Light Brown, Cool Ash Blonde, Platinum Blonde, Medium Ash, and Silver.

The “Warm” hair tone colors include Copper, Light Golden Copper, Golden Blonde, Light Golden Blonde, Light Blonde, Light Warm Brown, Strawberry Blonde, Light Gold Blonde, Sandy Blonde, and Pale Blonde.

### Clothing Analysis

Step 5: According to the preferred embodiment, analysis on clothing may be performed to determine the types and color of clothing that will complement a customer discovering their power colors in skin tone and hair color. The clothing is classified according to the “shades.” The shades comprise Cool, Light Cool, Warm, and Pastel or Light Warm.

To a person of ordinary skill in the art, “Cool” shading includes the colors of Black, Dark Red, Royal Blue, Neon Yellow, Kelly Green, Teal, Sky Blue, Light Pink, Sage, Mint, or Purple.

To a person of ordinary skill in the art, “Light Cool” shading includes the colors of Midnight Blue, Red, Pink, Magenta, Lilac, Light Yellow, Off White, Sand, Blue, or Light Blue.

To a person of ordinary skill in the art, “Warm” shading includes the colors of Dark Orange, Brown, Violet, Lime Green, Dark Olive, Oveltine, or Rose Gold.

To a person skilled in the art, “Pastel” or “Light Warm” shading includes the colors of Plum, Peach, Blue, Copper, Orange, Mist Gold, or Shrimp.

### Somatotopic Analysis

Step 6: A somatotype is the body build based on certain characteristics. A somatotopic analysis may be performed to assess a customer's physical shape. According to the preferred embodiment, a person skilled in the art performs a somatotopic analysis to determine the selections made in the hair colorimetry and clothing analyses balances with a customer's skin tone and facial shape.

There are eight different body types according to a preferred embodiment, as shown in FIGS. 8A and 8B, and as defined as:
Straight: a straight body type is defined by the bust and hips are similar in size, with a slight indentation in the waist.
Spoon: a spoon body type is defined by the hips measuring wider in size than the bust, with a slight indentation in the waist.
Top Hourglass: a top hourglass body type is defined by the bust measuring wider than the hips, with a defined waist.
Oval: an oval body type is defined by the waist measuring wider than the bust and hips, but the hips being narrower than the shoulders and the bust is large.
Pear: a pear body type is defined by the bust measuring smaller than the hips and a slight indentation in the waist.
Hourglass: an hourglass body type is defined by the bust and hips as similar in size, with a defined waist.
Inverted Triangle: an inverted triangular body type is defined by a wider bust with narrower hips, and an undefined waist.
Diamond: a diamond body type is defined by a wider waist than the bust, and the hips wider than the waist, and a medium-sized bust.

After a person of ordinary skill in the art has determined a customer's body type, a person skilled in the art may use the “Power Colors” chart, and as shown in FIGS. 8A and 8B, to determine the clothing shade and style as defined in Step 5 that will best enhance a customer's body style, facial shape, and skin tone.

### Optical Enhancement Analysis

Step 7: Based on the selection of a customer's facial shape from Step 2, a person of ordinary skill in the art may make an assessment on optical enhancements to best fit a customer's facial shape, as shown in FIGS. 8A and 8B. The optical enhancement corresponding to the particular facial shape is as follows:
Oval: translucent eyewear with a minimalistic frame that does not cover the cheekbone.
Oblong Rectangle: rounded angular eyewear with dark frames.
Rectangle: wider, round and triangular eyewear with dark frames.
Round: horizontally rectangular eyewear with dark frames.
Square: triangular and pointed eyewear with dark frames.
Triangle: translucent eyewear with minimalistic frames and wide noseguard.
Inverted Triangle: wide, rounded eyewear with thin frames and wide noseguard.
Heart: translucent eyewear with minimalistic frames and wide noseguard.
Diamond: round eyewear with thin frames.

### Data Management and Analysis

Step 8: After completion of some or all of the steps in artistic imagery consultation process, a person of ordinary skill in the art may record a customer's measurements, facial shape, skin tone, hair colorimetry, somatotopic type, and clothing shading and generates the results for a customer to use in managing their future style.

Although the present invention has been described in considerable detail with reference to certain preferred versions thereof, other versions are possible. Therefore, the spirit and scope of the appended claims should not be limited to the description of the preferred versions contained herein.

1. A method of an artistic imagery consultation comprising the steps of:
a. filling out a questionnaire;
b. performing a facial analysis through measurement of a customer's face to determine the facial shape;
c. performing a skin tone analysis to determine a customer's skin pigmentation;
d. performing a hair colorimetric analysis to determine a customer's hair color tone;
e. performing a clothing shade analysis to determine the optimal clothing colors based on a customer's facial, skin tone, and hair colorimetric analyses;
f. performing a somatotopic analysis to determine a customer's body type;
g. performing an optical enhancement analysis to determine the eyewear to augment a customer's facial shape, skin tone, hair colorimetry, clothing shade, and somatotopic analyses; and
h. generating data results for management of future image style.

2. The method according to claim 1, wherein the questionnaire is to assess a customer's overall expectations and goals in having an image consultation.

3. The method according to claim 1, wherein the facial shape is selected from a group consisting of oval, rectangle, oblong rectangle, round, square, triangle, inverted triangle, heart, and diamond.

4. The method according to claim 1, further comprising the skin tone colors of gold, light gold, and either silver or white.

5. The method according to claim 1, further comprising the hair color tones of Cool and Warm.

6. The method according to claim 5, wherein
a. the Cool hair color tone is selected from a group consisting of Blue Black, Cool Red, Dark Brown, Wine Red, Chocolate Brown, Ash Light Brown, Cool Ash Blonde, Platinum Blonde, Medium Ash, and Silver;
b. the Warm hair color tone is selected from a group consisting of Copper, Light Golden Copper, Golden Blonde, Light Golden Blonde, Light Blonde, Light Warm Brown, Strawberry Blonde, Light Gold Blonde, Sandy Blonde, and Pale Blonde.

7. The method according to claim 1, further comprising the clothing shades of Cool, Light Cool, Warm, and Pastel.

8. The method according to claim 7, wherein
a. the Cool clothing shade is selected from a group consisting of Black, Dark Red, Royal Blue, Neon Yellow, Kelly Green, Teal, Sky Blue, Light Pink, Sage, Mint, or Purple;
b. the Light Cool clothing shade is selected from a group consisting of Midnight Blue, Red, Pink, Magenta, Lilac, Light Yellow, Off White, Sand, Blue, or Light Blue;
c. the Warm clothing shade is selected from a group consisting of Dark Orange, Brown, Violet, Lime Green, Dark Olive, Oveltine, or Rose Gold;
d. the Pastel clothing shade is selected from a group consisting of Plum, Peach, Blue, Copper, Orange, Mist Gold, or Shrimp.

9. The method according to claim 1, the somatotopic type is selected from a group consisting of Straight, Spoon, Top Hourglass, Oval, Pear, Hourglass, Inverted Triangle, and Diamond.

10. A tool kit system of an artistic imagery consultation comprising:
a. a questionnaire;
b. a chart to assist performing a facial analysis through measurement of a customer's face to determine the facial shape;
c. scarves to assist performing a skin tone analysis to determine a customer's skin pigmentation;
d. hair tone samples and hair extensions to assist performing a hair colorimetric analysis to determine a customer's hair color tone;
e. scarves to assist performing a clothing shade analysis to determine the optimal clothing colors based on a customer's facial, skin tone, and hair colorimetric analyses;
f. a chart to assist in performing a somatotopic analysis to determine a customer's body type; and
g. a chart to assist in performing an optical enhancement analysis to determine the eyewear to augment a customer's facial shape, skin tone, hair colorimetry, clothing shade, and somatotopic analyses.

11. The tool kit system according to claim 10, further comprising scarves in the colors of gold, light gold, silver, and white.

12. The tool kit system according to claim 10, further comprising the hair tone samples in the colors of Cool and Warm.

13. The tool kit system according to claim 12, wherein
a. the Cool hair color tone is selected from a group consisting of Blue Black, Cool Red, Dark Brown, Wine Red, Chocolate Brown, Ash Light Brown, Cool Ash Blonde, Platinum Blonde, Medium Ash, and Silver;
b. the Warm hair color tone is selected from a group consisting of Copper, Light Golden Copper, Golden Blonde, Light Golden Blonde, Light Blonde, Light Warm Brown, Strawberry Blonde, Light Gold Blonde, Sandy Blonde, and Pale Blonde.

14. The tool kit system according to claim 10, further comprising the clothing shades of Cool, Light Cool, Warm, and Pastel.

15. The tool kit system according to claim 14, wherein
a. the Cool clothing shade is selected from a group consisting of Black, Dark Red, Royal Blue, Neon Yellow, Kelly Green, Teal, Sky Blue, Light Pink, Sage, Mint, or Purple;
b. the Light Cool clothing shade is selected from a group consisting of Midnight Blue, Red, Pink, Magenta, Lilac, Light Yellow, Off White, Sand, Blue, or Light Blue;
c. the Warm clothing shade is selected from a group consisting of Dark Orange, Brown, Violet, Lime Green, Dark Olive, Oveltine, or Rose Gold;
d. the Pastel clothing shade is selected from a group consisting of Plum, Peach, Blue, Copper, Orange, Mist Gold, or Shrimp.

16. The tool kit system according to claim 10, the somatotopic type is selected from a group consisting of Straight, Spoon, Top Hourglass, Oval, Pear, Hourglass, Inverted Triangle, and Diamond.
